(19) United States
(12) Patent Application Publication
(10) Pub. No.: US 2008/0028312 A1
(43) Pub. Date: Jan. 31, 2008

(54) SCENE ORGANIZATION IN COMPUTER-ASSISTED FILMMAKING

(75) Inventors: Donald Alvarez, Woodinville, WA (US); Mark Parry, Huntington Beach, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Accelerated Pictures, Inc., Redmond, WA (US)

(21) Appl. No.: 11/829,722

(22) Filed: Jul. 27, 2007

Related U.S. Application Data
(60) Provisional application No. 60/833,905, filed on Jul. 28, 2006.

(51) Int. Cl. G06F 3/00

(52) U.S. Cl. 715/719

(57) ABSTRACT

Novel tools that allow a user to organize filmmaking work. In some cases, a user interface can allow the user to organize filmmaking components directly in the filmmaking software, without necessarily requiring the user to explicitly use a file structure on a hard disk for organizational purposes, as some have done in the past. Further, some embodiments provide the ability for a user to organize his or her work into scenes, which contain one or more actions, again without needing to leave the tool or make use of a file system for organizational purposes. Novel data structures are provided by some embodiments to facilitate this organization.

### CROSS-REFERENCE TO RELATED APPLICATIONS

The present disclosure may be related to the following commonly assigned applications/patents (referred to herein as the “Related Applications”):

This application claims priority from co-pending provisional U.S. Patent Application No. 60/833,905, filed Jul. 28, 2006 by Alvarez, et al. and entitled “Scene Organization in Computer-Assisted Filmmaking,” which is hereby incorporated by reference, as if set forth in full in this document, for all purposes.

This application is related to U.S. patent application Ser. No. 11/262,492, filed Oct. 28, 2005 by Alvarez et al. and entitled “Client/Server-Based Animation Software, Systems and Methods,” which is hereby incorporated by reference, as if set forth in full in this document, for all purposes.

This application is also related to U.S. patent application Ser. No. 11/261,441, filed Oct. 28, 2005 by Alvarez et al. and entitled “Camera and Animation Controller, Systems and Methods,” which is hereby incorporated by reference, as if set forth in full in this document, for all purposes.

This application is further related to U.S. patent application Ser. No. 11/829,548, filed on a date even herewith by Alvarez et al. and entitled “Improved Camera Control” (attorney docket no. 020071-000510US), which is hereby incorporated by reference, as if set forth in full in this document, for all purposes.

The respective disclosures of these applications/patents are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates the field of computer-assisted animation and filmmaking in general and in particular to the organization of scenes in such works.

### BACKGROUND

It is common in traditional live-action filmmaking to organize parts of a story into components called scenes. This organizing of the story into scenes is typically done by the writer of the screenplay from which the film is made. The writer is typically concerned with thematic and dramatic issues and will define the scenes accordingly. When the film is produced, however, it is common to want to break the scenes into smaller groupings that reflect production issues such as limiting the time that an expensive actor or prop is needed on set. In other words, the organization of a film by scenes reflects the writer's creative and/or thematic judgment, but it does not necessarily track the business or production needs of the filmmaker and/or studio (which might need to know, for example, which portions of a film require a particular character, sound stage, etc., for scheduling or other purposes).

In live-action filmmaking, this breaking down of scenes into smaller pieces is done in an ad hoc manner. There is no standard or even commonplace terminology for portions of the story/film smaller than a scene. The closest term that we have identified is “setup,” which refers to a single camera setup (the camera typically being moved or re-setup for each of the sub-scene components). It is common for multiple cameras to be running simultaneously when a film is being shot (this is referred to as having “multiple coverage”), and each camera typically represents a separate setup.

In the past, computer animation filmmaking tools have avoided formally incorporating any type of grouping structure and instead expected the user to provide any such structure by way of the file system on the user's computer. A user might be expected, for example, to create a collection of directories on his or her computer hard drive. Each of these directories, then, might hold the data associated with one scene or some other portion of the overall story.

Thus, there is a need for improved tools for organizing data in a filmmaking application, and, in particular, tools that could provide a more granular level of organization than scenes in a film. Such tools would be helpful in the context of both live-action filmmaking and animated filmmaking.

### BRIEF SUMMARY

In an aspect, certain embodiments of the invention provide novel tools that allow a user to organize filmmaking work. In some embodiments, a user interface is provided; this user interface can, in an aspect, allow the user to organize filmmaking components directly in the filmmaking software, without necessarily requiring the user to explicitly use a file structure on a hard disk for organizational purposes, as some have done in the past. Further, some embodiments provide the ability for a user to organize his or her work into scenes, which contain one or more actions, again without needing to leave the tool or make use of a file system for organizational purposes. Novel data structures are provided by some embodiments; these data structures can facilitate this organization.

In an aspect, then, certain embodiments of the invention provide an enhanced level of organizational control over the process of computer-assisted filmmaking. Merely by way of example, in a set of embodiments, a data structure might imposes relatively granular organizational controls over the filmmaking components that make up a film. This feature can provide several benefits, including, inter alia, more efficient production of films, facilitation of collaborative efforts among multiple animators and/or filmmakers, and more robust version and/or change management features.

Beneficially, certain embodiments of the invention can allow organization of a film according to production values, as opposed to mere organization into scenes. For example, in an aspect, the organizational tools provided by various embodiments of the invention allow the filmmaker to quickly ascertain each point in the film where a particular component is used. This can, for example, facilitate the scheduling of resources (sound stages, props, lighting and/or camera equipment, actors, etc.) as well as allow a production element to be modified once with applicability throughout the film, among other benefits. Hence, embodiments of the invention can provide greatly enhanced efficiency in the filmmaking process.

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like). In a particular embodiment, the set of instructions might be incorporated within a filmmaking application and/or might be provided as a separate computer program that can be used to provide an interface and/or a data structure for a filmmaking application.

Merely by way of example, one set of embodiments provides methods, including without limitation methods of organizing data in a computer-assisted filmmaking application. An exemplary method might comprise accessing a data structure, which might be configured to store data about a film. In an aspect, the film is organized into a plurality of scenes, each of which comprises one or more actions. Each action might employ one or more production elements. The method, in some embodiments, further comprises providing a user interface for a user to interact with the data about the film, and/or receiving, via the user interface, a selection of a first scene, which comprises a first action. The method might further comprise identifying the first action, based, perhaps, on the selection of the first scene, and/or displaying, via the user interface, a representation of the first action.

Another set of embodiments provides data structures, including without limitation, data structures for storing data used by a computer-assisted filmmaking application. An exemplary data structure is encoded on a computer-readable medium, and it might comprise a plurality of scene objects comprising data about a plurality of scenes in a film. In an aspect, the plurality of scene objects comprises a first scene object representing a first scene in the film. The first scene object might have a first scene identifier.

In some cases, the data structure further comprises a plurality of action objects comprising data about a plurality of actions within the film. The plurality of action objects might comprise a first action object representing a first action; the first action object might have a first action identifier. The plurality of action objects might also comprise a second action object representing a second action and having a second action identifier.

In an aspect, the data structure might further comprise a plurality of production element objects comprising data about a plurality of production elements within the film. The plurality of production element objects could comprise a first production element object and a second production element object. Each of the production element objects might comprise a production element identifier.

In an aspect, of certain embodiments, the data structure further comprises a first relationship between the first scene object and the first action object, indicating that the first scene comprises the first action, and/or a second relationship between the first action object and the first production element object, indicating that the first production element is used in the first action. In some cases, the relationship between two objects comprises a reference in one object to the other object. In other cases, each of the objects might be defined by a respective data class. In yet other cases, a production element object might comprise a rig having a set of controls; the set of controls might include a first control for controlling a first manipulable property of the first production element. In a particular aspect, the data structure might comprise an array of tags; each tag can be used to identify a characteristic of an object (or a filmmaking component represented by the object) associated with the tag. The tags may be searchable by a user to identify filmmaking components (e.g., production elements) having a specified characteristic.

As noted above, another set of embodiments provides user interfaces, including without limitation user interfaces for organizing data in a filmmaking application. An exemplary embodiment comprises a computer readable medium having encoded thereon a computer program comprising a set of instructions executable by a computer to generate a user interface for a computer-assisted filmmaking application. In an aspect, the user interface might comprise a scene selection element for a user to select a first scene object corresponding to a scene from a film. The scene object may be related to a plurality of action objects, including, inter alia, a first action object corresponding to a first action and a second action object corresponding to a second action. This relationship could indicate that the scene comprises the first and second actions. The user interface might further comprise an action selection element for a user to select one of the plurality of action objects and/or an action modification element for a user to modify the selected one of the plurality of action objects.

Another set of embodiments provides computer systems. An exemplary computer system might comprise a processor and a computer readable medium. In an aspect, the computer readable medium has encoded thereon a data structure to store data about a film, which might be organized into a plurality of scenes, each of which comprises one or more actions. Each action might employ one or more production elements.

In another aspect, the computer readable medium might have encoded thereon a computer program comprising a set of instructions executable by the computer system to perform one or more operations. The set of instructions might comprise instructions for accessing the data structure and/or instructions for providing a user interface for a user to interact with the data about the film. In some embodiments, the set of instructions further includes instructions for receiving, e.g., via the user interface, a selection of a first scene, which comprises the first action. There may also be instructions for identifying the first action, based on the selection of the first scene and/or instructions for displaying, via the user interface, a representation of the first action.

In an aspect, the user interface might be provided by communicating with a client computer configured to display the user interface. This communication might comprise communicating with a web browser on the client computer via a web server to cause the web browser to display the user interface. In an aspect, the computer system might comprise the web server.

Yet another set of embodiments provides computer programs. Merely by way of example, a computer readable medium might have encoded thereon a computer program comprising a set of instructions executable by a computer to perform one or more operations. The set of instructions might comprise instructions for accessing a data structure, such as the data structure described above, to name one example. The program might further comprise instructions for providing a user interface for a user to interact with the data about the film and/or instructions for receiving, via the user interface, a selection of a first scene comprising a first action. There might be further instructions for identifying the first action, based on the selection of the first scene, and/or for displaying, via the user interface, a representation of the first action.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is block diagram illustrating a data structure, in accordance with various embodiments of the invention.

FIGS. 2A and 2B illustrate exemplary user interfaces, in accordance with various embodiments of the invention.

FIG. 3 is a block diagram illustrating the functional components of a computer system, in accordance with various embodiments of the invention.

FIG. 4 is a process flow diagram illustrating a method of organizing data in a computer-assisted filmmaking application.

FIG. 5 is a generalized schematic diagram illustrating a computer system, in accordance with various embodiments of the invention.

FIG. 6 is a block diagram illustrating a networked system of computers, which can be used in accordance with various embodiments of the invention.

### DETAILED DESCRIPTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below, and while various features are ascribed to different embodiments, it should be appreciated that the features described with respect to one embodiment may be incorporated with another embodiments as well. By the same token, however, no single feature or features of any described embodiment should be considered essential to the invention, as other embodiments of the invention may omit such features.

Various embodiments of the invention provide novel tools (including, without limitation software, systems and methods) for animation and/or filmmaking. (The term “filmmaking” is used broadly herein to connote creating and/or producing any type of film-based and/or digital still and/or video image production, including without limitation feature-length films, short films, television programs, etc. Likewise, the term “film” is used broadly herein to refer to any type of production that results from filmmaking.) In particular, embodiments the invention, in various aspects, provide novel tools for organizing, displaying, navigating, creating and/or modifying various filmmaking components. (As used herein, unless the context dictates otherwise, the term “filmmaking components” or more generally “components” refers to any of the components that make up a film, including without limitation scenes, actions, animations, and sounds as well as physical and/or virtual characters, sets, props, sound stages, and any other artistic and/or production elements.)

A few filmmaking components in particular are discussed extensively herein and merit further attention. A “scene” is a portion of a film; in an aspect, a film is divided into a number of scenes, based often on the writer's thematic and/or artistic purposes. An “action” is a portion of a scene; that is, a given scene might be subdivided into any number of actions. In a particular aspect, a scene may be divided into actions into such a way to address production concerns and/or to facilitate the filmmaking process. “Production elements” are individual components that are used to create an action, and can include, without limitation, characters, sets, sound stages, props, sounds, real or virtual cameras, real or virtual lights, and or other artistic and/or production-related elements which are associated with one or more scenes and/or actions. An “animation” (when that term is used herein as a noun) is the data that defines or specifies how a production element moves, performs, acts or otherwise behaves. An animation can be created and/or modified using, inter alia, animation software, filmmaking software, and/or the like.

In particular, certain embodiments provide access to a plurality of animated behaviors associated with a story. (In an aspect, this invention recognizes that the writer's scene organization is a desirable but insufficient structure for breaking down the screenplay into producible elements, and that extending the structure to have formal components that are smaller than (and/or contained within) a scene is yet another significant advance. As noted above, this document uses the term action to refer to these sub-scene story components, which may be employed in either animated or live-action films (or films that combine both animation elements and live action elements).

Embodiments of the invention can be implemented in, and/or in conjunction with, an animation software package. Examples of such software packages include, without limitation those described in the Related Applications, which are already incorporated by reference. Merely by way of example, one or more of the scene organization features (such as user interfaces and/or data structures, to name but two examples) described herein can be incorporated into an existing animation software package, for example as an add-on or plugin, through the use of application programming interfaces (“API”) and/or as an integral part of the animation software itself.

Tools provided by various embodiments of the invention allow, in some aspects, a user to select and/or navigate a set of scenes and/or actions, for example, by presenting to the user either a full text representation of the script of the story; a reduced-format representation of the script, such as scene names, scene numbers, and/or some other identifier of scenes; and/or some other representation of the scene (such as a portion of the film comprising the scene, a listing of one or more scenes by name, etc. The software, then, might identify the action(s) associated with the selected scene and and/or makes those actions available to the user for review, manipulation, and/or other purposes, for example by providing focus to those actions in a user interface of the software, by loading those actions from disk, etc.

Certain embodiments of the invention, then, provide filmmaking software (which includes, but is not limited to, computer animation software) that allows a user to organize his or her work into scenes (as in the screenplay), as well as more granular actions, directly in the filmmaking software, without requiring the user to explicitly use a file structure on a hard disks for organizational purposes. (While a data structure might, as described in detail below, be stored on a hard disk, various embodiments of the invention provide inherent organization of filmmaking components, freeing the user from having to organize the components on disk him- or herself.). Further, some embodiments provide the ability for a user to organize his or her work into scenes, which contain one or more actions, again without needing to leave the tool or make use of a file system for organizational purposes.

In an aspect, then, these embodiments provide an enhanced level of organizational control over the process of computer-assisted filmmaking. Merely by way of example, in a set of embodiments, a data structure (which might be stored in a database, file system, and/or the like, which can be either external or internal (or both) to the software itself), imposes relatively granular organizational controls over the filmmaking components that make up a film. This can provide several benefits, including without limitation more efficient production of films, facilitation of collaborative efforts among multiple animators and/or filmmakers, and more robust version and/or change management features.

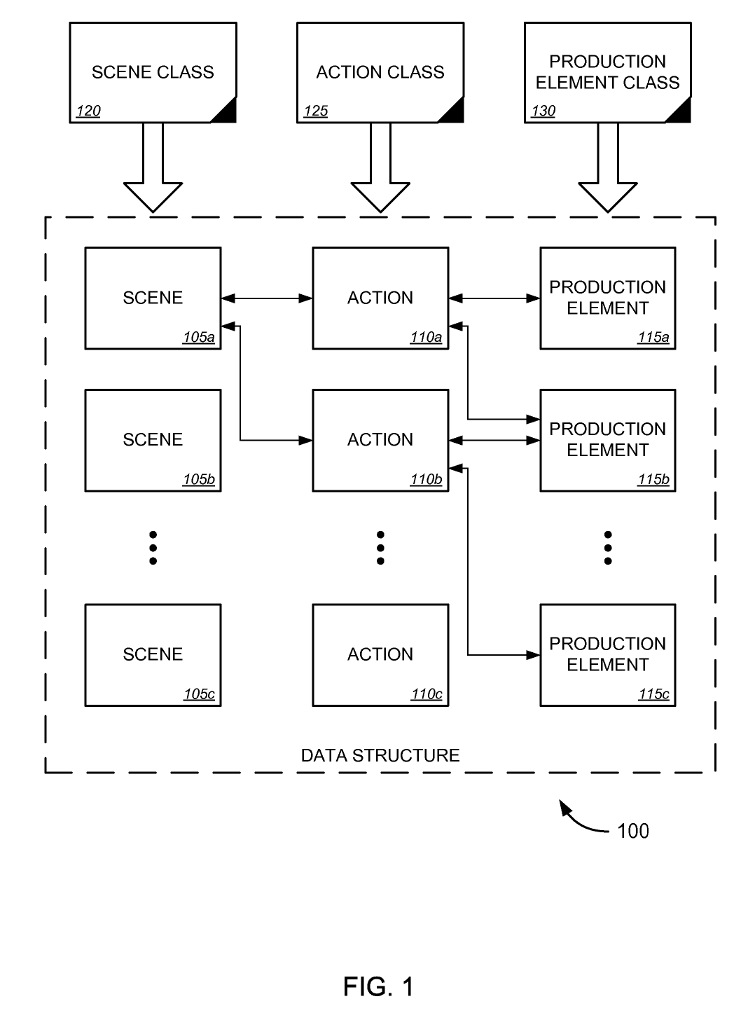

An example of one such data structure 100, in accordance with a set of embodiments, is illustrated by FIG. 1. The data structure 100 comprises a plurality of scene objects 105, a plurality of action objects 110, and a plurality of production element objects 115. In an aspect, each scene object 105 also has an associated identifier (such as an alphanumeric string, etc.) that identifies that scene within the data structure and/or filmmaking application; similarly as does each action object 110 and each production element object 115 might have an action identifier or a production element identifier, respectively. (Optionally, as described below, there may be animation objects to represent animations; these objects may have identifiers as well. In other cases, animations may be represented by production element objects 115.) Objects are used within the data structure to represent various filmmaking components, providing filmmaking software with a way to refer to different types of components that otherwise would be difficult to categorize and manage.

In some cases, the object representing a filmmaking component might actually store the component and/or a representation thereof (such as an image, a set of commands to create the component, etc.) In other cases, the object might serve as a placeholder and/or a container for data about the component (as in the case of physical components, such as physical props, etc.) In yet other cases, the object can serve both purposes. These different types of objects can all be accommodated and/or intermingled in accordance with various embodiments of the invention.

Each scene object 105 represents one of a plurality of scenes in particular film, and it contains data about that scene. (Although this example considers a data structure organizing data for a single film, it is possible that a data structure might hold data for a plurality of films; alternatively and/or additionally, each film might have its own data structure or plurality of data structures.) Merely by way of example, a scene object 105 might store data about the location of a scene within a film, the setting of the scene, and/or the like. Similarly, each action object 110 comprises data about the action it represents, and each production element 115 comprises data about the production element it represents. This data might be, but need not necessarily be, stored as properties in the respective objects.

In a novel aspect, the data structure also comprises, stores and/or provides a relationships between various objects. Merely by way of example, a relationship between a scene object 105 and an action object 110 indicates that the action appears in the scene represented by the scene object (i.e., that the scene comprises the action in the film, although the scene object 105 will not necessarily comprise the action object 110—instead, as noted, they might be related in the data structure), and a relationship between an action object 110 and a production element object 115 indicates that the production element represented by the production element object 115 is used (in the film) in the action represented by the action object 110. (In various other embodiments, different types of objects might have relationships; for example, a scene object 105 might also have a relationship with a production element object 115, a production element object 115 and/or an action object 110 might have a relationship with an animation object, if the embodiment supports such objects, etc.) In one aspect, although a database need not be used to store the data structure 100 (and the data structure 100, in many embodiments, provides functional exceeding that of a typical database), the relationships created or maintained by the data structure can be thought of as somewhat analogous to the relationships employed by relational database management systems.

In a set of embodiments, the relationship between two objects might be implemented and/or might comprise a reference, stored in one object, to another object. Merely by way of example, a relationship between a scene object 105 and an action object 110 might comprise (and/or be represented and/or implemented by) a reference from the action object 110 to the scene object 105; the action object 110 might comprise the reference (e.g., the reference might be stored in the action object 110). In other embodiments, the same relationship might be represented by a reference to the action object 110; and the scene object 105 might comprise this reference. In yet other cases, the action object 110 and the scene object 105 might both store a reference to the other. Relationships between other types of objects might be implemented in similar ways. For example, a relationship between an action object 110 and a production element object 115 might be implemented by the production element 115 comprising a reference to the action object 110 (or vice-versa, or both).

In some cases, the objects reference one another using the identifiers described above. Merely by way of example, an object might store identifier(s) for one or more other objects in a “reference” field or property in that object, which can be used by the software to ascertain the relationship(s) that object has with the other object(s).

Examples of these relationships are illustrated by the data structure 110 of FIG. 1, in which a particular scene object 105a has relationships to two action objects 110a, 110b (as shown by the double-ended arrows on FIG. 1), indicating that the scene represented by the scene object 105a comprises the actions represented by those action objects 110a, 110b. Similarly, an action object 110a has a relationship with two production element objects 115a, 115b, indicating that the production elements represented by those objects 115a, 115b are used in action represented by the action 110a.

In an aspect of some embodiments, each production element (e.g., a character, etc.) has only a single corresponding production element object 115a. Accordingly, if that production element is to be used in multiple actions, the action object 110 for each such action might be related to the production element object 115. For example, the action objects 110a, 110b representing two different actions each have a relationship with the same production element object 115b, indicating that the production element represented by that object 115b appears (or is used in) the actions represented by both objects 110a, 110b.

A production element object 115 can represent any type of production element, including without limitation those described above. As noted above, an animation is a set of data defining and/or specifying the behavior of a particular production element. Hence, in some cases, a production element object 115 can also represent an animation, while in other cases, there may be a separate type of object for animations. (While an animation object is not illustrated in FIG. 1, it should be appreciated that an animation object, similar to other objects described above, might have an identifier as well as data about the animation, including for example, a reference to a location on a disk of the file in which the animation is stored and/or references to production elements used within the animation. Similarly, an animation data object might be defined by an animation data class, in the fashion described below.) In embodiments that support discrete animation objects, an animation object might have a relationship with the production element object 115 representing production element for which it defines a behavior and/or an action object 110 representing the action in which that production element exhibits that behavior.

The software might also be configured to store the script (and/or textual information associated with the script, such as dialog, descriptions, slug lines, etc.), either inside or outside the data structure. Merely by way of example, a scene object 105, action object 110 and/or production element object 115 might store those portions of the script (and/or associated textual information) that pertain to the respective object. Alternatively and/or additionally, the data structure might maintain a relationship between a scene object 105, an action object 110 and/or a production element object 115 and the script and/or other textual information (or portions thereof that relate to the respective object). (Scripts and other textual information might be, but need not be, stored as one or more separate object(s) in the data structure, which might be defined, for example, by a script data class, in the fashion described below.) Merely by way of example, a production element object 115 representing a character might store and/or have a relationship with portions of the script containing dialog spoken by that character, etc.

According to some embodiments, the objects 105, 110, 115 may be defined by respective classes, similar to typical object-oriented programming principles. Hence, a scene object 105 might be defined by a scene data class 120, which provides a framework for properties that each scene 105 should have (of course, each scene 105 need not necessarily have the same values for respective properties as other scenes). Similarly, each action object 110 might be defined by an action data class 125, while each production element object 115 might be defined by a production element data class 130. These data classes, in an aspect, provide a template for their respective objects, ensuring that the objects adhere to a consistent data framework and facilitating the creation of new objects. (For instance, a data class might provide default values for one or more properties of the objects defined by the data class.) As noted above, additional types of objects (such as script objects, animation objects, rig objects etc.) can be defined by appropriate data classes. In this regard, the data structure can be extensible to support a variety of different types of objects.

In some cases, a data class might be separated into different types of classes (and/or have subclasses). Merely by way of example, a production element data class might have different subclasses for different types of production elements (such as characters, lights, etc.). In other cases, certain production elements might have an associated “rig,” which can be used (especially in the case of virtual production elements, such as animated characters, virtual lights, cameras, vehicles, props, etc.) to control the manipulable properties of the production element during when the production element is used in an action and/or scene. (The term “rig” is used herein to refer both to skeletons for character production elements and camera and/or lighting rigs, which are both described in further detail in the Related Applications.)

In some cases, the data class (or subclass) for a production element will provide a default rig for the production element. In other cases, however, the user might simply select (and/or create, import, etc.) the rig to be used for a particular production element. In either cases, however, the production element object for that production element might comprise one or more properties pertaining to the rig.

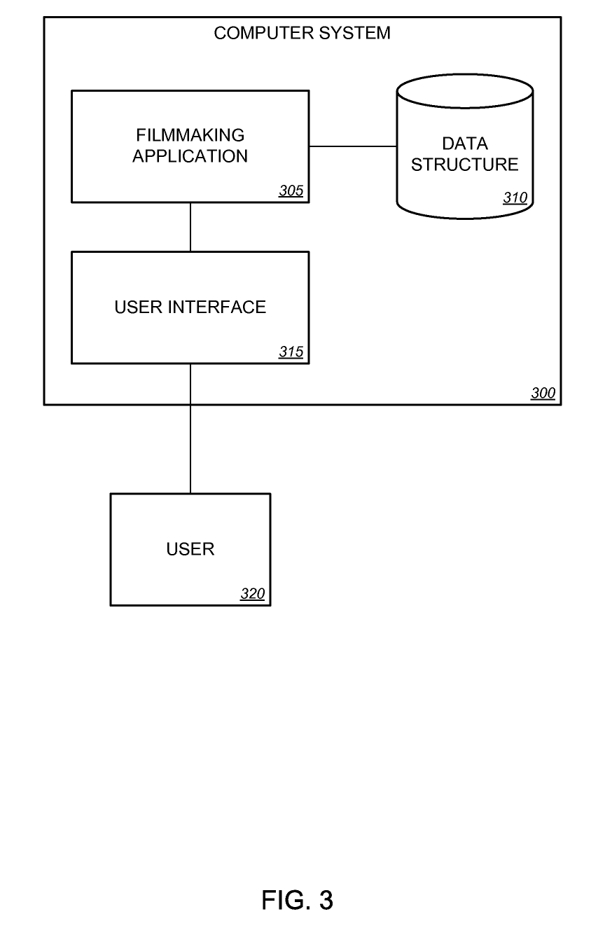

In yet other cases, different rigs might be represented by rig objects in the data structure 100. In such cases, a production element object 115 might be related to a rig object (not illustrated on FIG. 3) indicating that the rig to be used on or by the production element represented by that object 115 (for example, to create animations using the production element). This rig object, then, might comprise a variety of properties relating to the manipulable characteristics of the rig.

In another novel aspect of certain embodiments, the user may be provided with the ability to provide “tags” for various objects (including, in particular, production elements, but also including actions, scenes, rigs, animations, portions of the script, etc.). Some tags might be provided by the software, while other tags can be user-defined. Tags provide a facility (separate from the hierarchy of the data structure, in some cases) for a user to identify characteristics of certain objects (and/or the filmmaking components they represent). As one example, a tag might identify a type of production element. For instance, if a production element object corresponds to a virtual miner character with a light on his helmet, the production element object might be tagged with a “character” tag, a “hero” tag, and a “light source” tag. These tags might, but need not necessarily, imply particular functionality of the tagged components. (For example, a “light source” tag might imply that the tagged production element emits light when used in an action, and/or might imply a particular rig to use to control the behavior of the light source.) Alternatively, a tag might (but need not) imply a default rig to use for a production element, while perhaps still allowing the user to override that default selection.

Tags can also be used to associate other data (including metadata) with a particular filmmaking component. Merely by way of example, the production element object for a particular prop might include a tag that indicates that the prop needs to be rented for the film, and/or provide details about the prop, such as when it will be available for filming. Hence, by searching for all such tags, the user can determine which filmmaking components might need to be rented or otherwise obtained. In addition, by tracking the availability of various production elements, the software can facilitate the scheduling of actions that use those production elements. Together with the organization imposed by the data structure 100 (e.g., the relationship between the scenes, actions and production elements), such tags allow the user to determine quickly which production elements need to be procured and/or provided and when. This functionality can greatly enhance the efficiency of the filmmaking process.

Other embodiments provide interfaces to allow a user to work with data about films (including, without limitation data stored in data structures such as the data structure 100 described above). Merely by way of example, an interface in accordance with certain embodiments may allow the user to select one or more scenes from a plurality of scenes in order to work with or review the actions, animations, and/or production elements associated with the selected scene(s). In some cases, the software is configured to present to the user a list of production elements, animations and/or actions, which would allow the user to select and/or identify one or more scenes by of selecting and/or identifying one or more production elements/animations/actions incorporated in those scenes. For instance, a certain animation might appear in actions three different scenes. Selection of this animation from the list of animations would cause those three scenes to be presented to the user, such that the user could select one or more of those scenes to work with. Conversely, by selecting a particular scene, the user can be given the option to work with one or more actions, production elements, etc. within that scene.

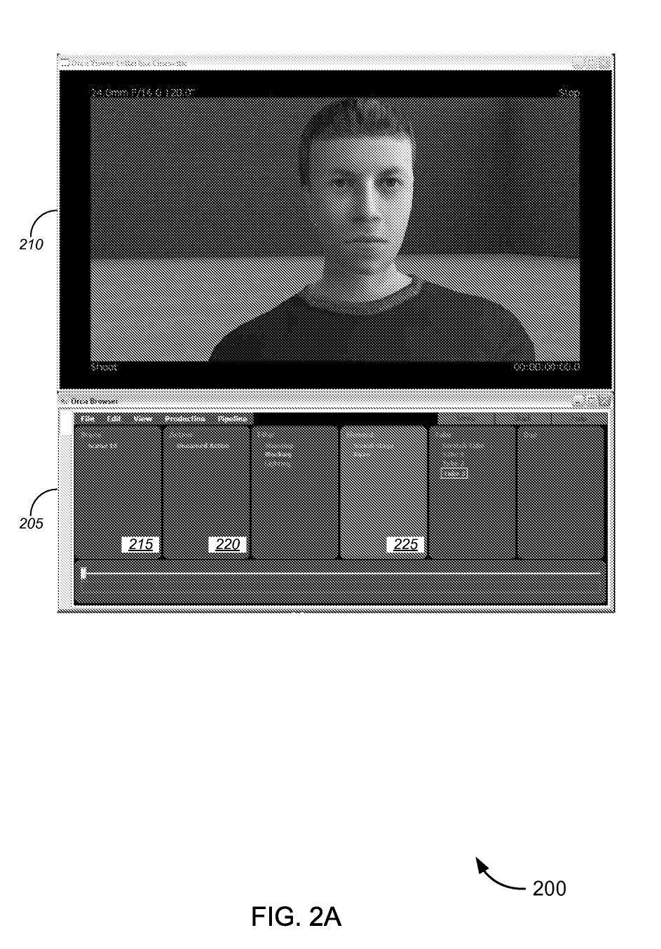

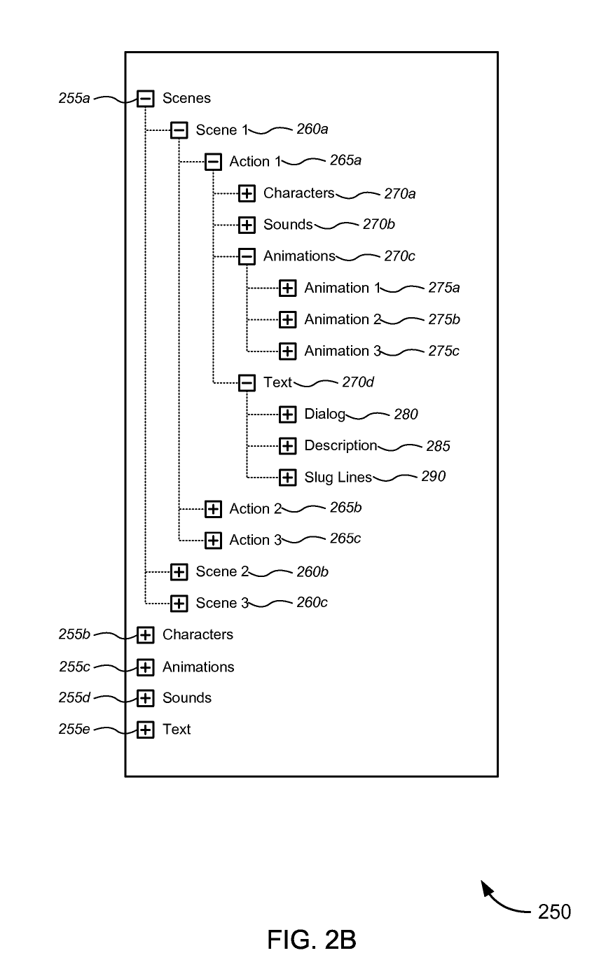

FIG. 2A illustrates one exemplary interface 200 that can be used by a user to interact with data about a film (e.g., by viewing and/or manipulating objects corresponding to various filmmaking components). (It should be appreciated that a variety of different interfaces are possible, and that embodiments of the invention are not limited to any particular functional or aesthetic arrangement.) In certain embodiments, the user interfaces of the invention are configured (or are configurable) to accept input from a variety of input devices, including without limitation the input devices and/or controllers described in the Related Applications. For example, a game controller might be used to navigate through the user interface, create and/or modify animations, etc.

The user interface 200 comprises two main portions. The first is a browsing window 205, which allows a user to browse and/or search among various filmmaking components (and in particular, among objects stored in a data structure, as described above for example). The second is a viewing window 210, which allows a user to view and/or edit details about (and/or a representation of) a selected filmmaking component (e.g., a scene, action, production element, etc.).

In operation, the browsing window 205 includes subwindows for displaying categorized lists of various filmmaking components, among other things. These subwindows can also be used to select a particular component of interest, and/or “drill down” through a hierarchy established by a data structure (e.g., by selecting a scene, an action, and a production element, etc.). Merely by way of example, a first subwindow 215 displays a list of one or more scenes, a second subwindow 220 displays a list of one or more actions, and a third subwindow 225 displays a list of one or more production elements. (These filmmaking components, in an aspect, correspond to objects stored in a data structure, such as the data structure 100 described above.)

Hence, for example, a user might select a scene in the first subwindow 215 (in this example, the user has selected “Scene 14,” which has caused the user interface to remove other scenes from the list in subwindow 215, but it should be appreciated that, if no scene had yet been selected, some or all of the scenes in the film might be shown on this list). Upon selection of a scene, the user interface 200 displays, in the second subwindow 220, a list of all actions incorporated in the scene (i.e., in an aspect, all actions represented by action objects for which the data structure maintains a relationship to the scene object representing the selected scene). Upon selecting an action in the subwindow 220 (in this case, the user has selected “Unnamed Action”), the user interface 200 displays, in the third subwindow 225, a list of production elements used by that action (again, perhaps by identifying all production element objects related to the action object representing the selected action). The user may then, if desired, select a production element for viewing and/or modification.

In an aspect, upon the selection of a particular filmmaking component (e.g., scene, action, production element, etc.), the viewing window 210 displays information about (and/or a representation of) the selected filmmaking component, allowing the user to view and/or modify the production element. In some cases, the viewer window might provide an interface to an animation program (and/or animation functionality of the program providing the user interface 200), allowing the user to create and/or modify animations for the selected action, etc. The animation program might have the functionality available in a variety of well-known animation products and/or might comprise some or all of the features of animation software described in detail in the Related Applications.

As another example, upon selection of a particular action, the user interface 200 might allow the user to modify the action. Examples of modifying an action can include generating new production elements for the action, associating (and/or disassociating) existing production elements with the action, etc. These modifications can result in corresponding modifications to the data structure (e.g., creating a new production element object, creating and/or destroying relationships between the action object and production element objects(s), etc.) and/or modifications to the script (for example, by removing a production element from an action, that production element might be removed from the corresponding portion of the script as well). Similarly, the user interface can provide a facility for modifying a scene (by adding actions to the scene and/or deleting actions from the scene, etc.); in some cases, modifying a portion of the script might also modify a scene corresponding to that portion (for example, changing dialog, etc.). Conversely, in some embodiments, by modifying the script, the user can modify any scenes, actions, etc. corresponding to the modified portions of the script.

The interface 200 might also include tools that allow the user to view and/or modify production elements (e.g., organized by scene and/or action), and optionally select one or more production elements to work with (e.g., edit, modify, create, and/or delete). Conversely, the user might be presented with a list of such elements, and then to select various animations, scene(s) and/or action(s) in which a desired production element is present to work with. These lists of elements might be user-modifiable and/or sortable, to allow for easier navigation. As with scenes and actions, modification of a production element can produce a modification of relevant portions of the script, and vice-versa.

In certain embodiments, the interface might also provide a facility that allows the user to copy and/or move animations from one production element to another (assuming that the production elements share similar enough rigs that the animation is valid for each) and/or one action to another (assuming the actions share the production element that the animation is related to), as well as to generate new animations, import animations from outside the filmmaking application, and/or the like. Animations might be associated exclusively with one action and/or production element; alternatively, animations might be associated with multiple actions and/or production elements, or with none. In cases in which animations are shared between actions and/or production elements, the user interface 200 might include a facility that allows the user to view and/or modify the sharing relationship between various actions (e.g., to establish and/or modify relationships between various action objects and animation objects).

As noted above, in a set of embodiments, textual information (such as dialog, descriptions, slug lines, etc.) from the script for a film can be stored by the software. Accordingly, the software can be configured to maintain (and/or present to the user, e.g. via a user interface) a relationship between such textual information and various scenes and/or actions (and/or elements thereof, such as sets of animations, characters, sounds, etc. Merely by way of example, each scene object might have a relationship with the portion(s) of the script that pertains to that scene; similarly, each action object might have a relationship with the portion(s) of the script that pertain to that action, and/or each production element object can have a relationship with the portions(s) of the script that pertain to that production element (for example, a production element object for a character might have a relationship with each location in the script where the character appears). In some cases, the user interface provides a facility for the user to define and/or modify such relationships; in other cases, the software might be configured to parse the script to identify at least some of these relationships (and/or to create the relevant objects based on this parsing—for example, if the script has a heading for each scene, the software could parse these headings to create scene objects for each scene found; similarly, the software could parse the script for character names to associate dialog with the production element objects for those characters).

Optionally, the user can modify textual information itself and/or the relationship between textual information and the scenes and/or actions (and/or elements thereof). The user interface 200 can be configured to provide for the display or modification of such information. Merely by way of example, the browsing window 205 might have a subwindow (not shown) that allows a user to select from a list of such textual information, and the viewing window 210 might be configured to allow the user to view and/or modify the selected information. As noted above, modification of the script can result in the modification of any corresponding objects.

In some cases, while description herein refers to the user interface 200 as allowing the user to select and/or modify various filmmaking components (which is how it might appear to the user), the user interface 200 might actually be allowing the user to select the object corresponding to the action, and/or to modify that object. Similarly, however, modification of the object for a particular component often will result in modification of the component itself in some fashion. Hence, from the user's perspective, whether the component or its corresponding object is being selected is generally immaterial. Hence, while this document sometimes refers to selection/modification of a component (e.g., from the user's perspective), such references should be understood also to include, in certain embodiments, the selection/modification of the corresponding object (rather than the component itself).

In some cases, the software may support additional and/or alternative organization structures, such as groupings of textual information in the script, animations, characters and/or other production elements, which are not necessarily subsets of scene groupings (for example, groupings which span several scenes or which span parts of several scenes). In a particular embodiment, such groupings may be presented hierarchically. Merely by way of example, a user interface might provide a navigation tool might presenting a tree structure (similar to the Microsoft Windows Explorer™) that allows grouping structures to be expanded and/or contracted as desired.

One such interface 250 is illustrated by FIG. 2B. The interface 250 can be used in addition to, and/or as an alternative to, various elements of the interface 200 of FIG. 2A. (For example, the browsing window 205 of FIG. 2A might be replaced and/or supplemented by the interface 250 of FIG. 2B.) The interface 250 provides a hierarchical view of the filmmaking components used in a particular film. (In an aspect, the interface 250 provides accessibility to various objects in the data structure, similar to the browsing window 205 described above.) In the interface 250, there are a set of top-level categories 255, such as categories for scenes 255a, characters 255b, animations 255c, sounds 255d and/or textual information 255e. Using these top-level categories, the user can browse various filmmaking components from a variety of perspectives (e.g., rather than having to navigate from scene to action to production element to find a particular character, the user can navigate from the top-level category 255b for characters).

The categories 255 are expandable, to allow a user to drill down into the hierarchy in a variety of fashions. So, for example, by expanding the scenes category 255a, the user is presented with a list of scenes 260 in the film. The user can further expand one of the scenes elements 260 to view and/or modify a list of action elements 265. Within a particular action 265a, there may be lists of various types of production elements, such as characters 270a , sounds 270b , etc. The action element 265a might also include a list of and/or textual information for the action 270d (which can include, inter alia, dialog 280, descriptions 285, slug lines 290, etc.). There might also be a list of animations 270c used in the action.

In an aspect the hierarchy of the interface 250 is established by the relationships between objects in the data structure that stores the objects used to populate the hierarchy. Hence, in another aspect, the user can changes these relationships by modifying (e.g., dragging, cutting and pasting, etc.) various elements in the hierarchy. For example, if the user wanted to include a particular character from Action 1 in Action 2, the user could copy the relevant character element from Action 1 to Action 2.

Using this navigation tool, users can easily select filmmaking components at any desired level of granularity, view and/or modify the relation between various components and/or select any desired components to work with.

Alternatively and/or additionally, any other arbitrary hierarchical and/or non-hierarchical groupings of various components (such as scenes, actions, animations and/or other elements) may be supported. For example, the user might be allowed to establish relationships between (and/or groupings comprising) objects corresponding to any desired components of the film. In further embodiments, the software may support the import and or export of grouping and or association data, in human and/or machine readable format. Merely by way of example, data about groupings and/or relationships might be maintained in (or exportable/importable via) standard markup language files, such as XML files. (In one aspect, the data structure(s) employed by embodiments of the invention might utilize XML files for organization as well.) Optionally, data about the film components themselves might be importable/exportable, using any of a variety of standard and/or proprietary formats (including without limitation various image formats, video formats, sound formats, text formats, and the like).

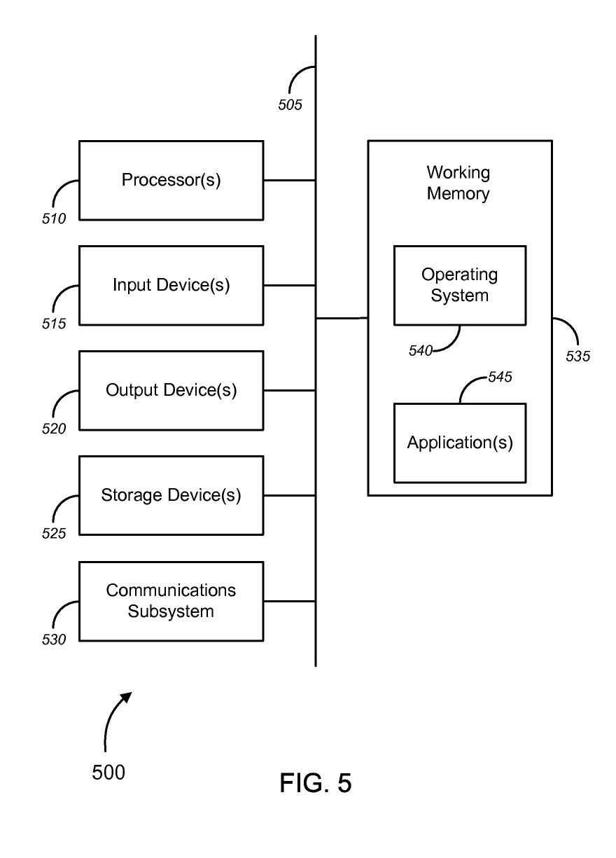

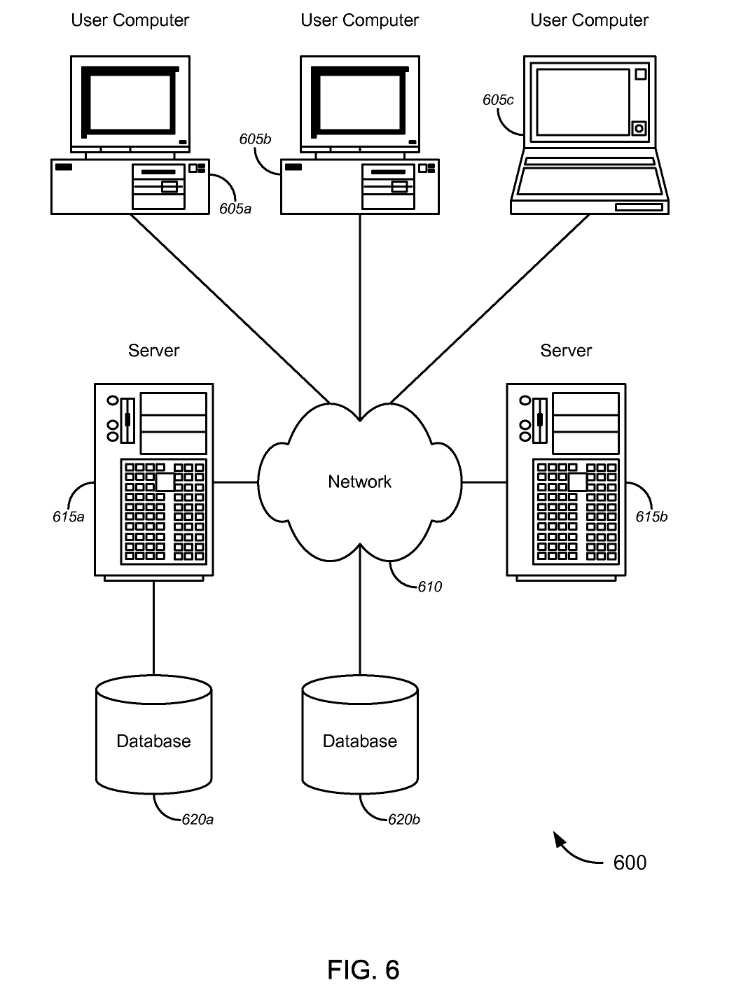

FIG. 3 illustrates a functional arrangement of software elements in a computer system 300, in accordance with one set of embodiments. (Exemplary architectural arrangements of computer systems, which might include the computer system 300, are described below with respect to FIGS. 5 and 6.) The computer system comprises a filmmaking application 305, which might be a filmmaking software application with the functionality described in any of the Related Applications, and/or might allow a user to perform any of the filmmaking tasks described herein to produce a film. The filmmaking application is in communication with a data structure 310 (which might be, but need not be, the data structure 100 described above). In an aspect, the data structure is configured to store data about a film, which, as noted above, might be organized into a plurality of scenes, each of which comprises one or more actions. Each action might employ one or more production elements, also as noted above.

The filmmaking application is also in communication (perhaps via an API) with a user interface 315, which might be (and/or might comprise the functionality of) any of the user interfaces described above. The user interface 315 allows a user 320 to interact with the filmmaking application 305. It should be noted that embodiments of the invention can exhibit substantial variation from the functional arrangement depicted in FIG. 3. Merely by way of example, the filmmaking application 305 might comprise the data structure 310 and/or the user interface 315. In another embodiment, the data structure 310 might be stored remotely, for example on a server computer. In yet another embodiment, the filmmaking application 305 itself might be served from a server computer, while the user interface 315 might be provided on a user computer in communication with a server computer.

In a particular aspect, the filmmaking application 305 might comprise and/or utilize a web server; in such embodiments, at least a portion of the user interface 315 might be provided to the user via a web browser, e.g., as a web application, series of web pages, and/or the like. Merely by way of example, in one set of embodiments, a user interface such as the user interface 200 described with respect to FIG. 2A can be provided partially and/or wholly as a web application. In an aspect, for instance, the browsing window 205 might be provided by a compiled executable that hosts a web browser (and/or is configured with an HTML rendering engine and/or HTTP capabilities), while the viewing window 210 might be provided by the compiled executable itself In this way, the browsing window 205 can be populated from a web server (which might be incorporated in, and/or in communication with, a server that hosts the data structure), while the viewing window 210 can serve as a viewer application and/or editor for various types of rich content (e.g., video, images, etc.) downloaded from the server in response to selection of various scenes, actions, production elements and/or the like.

In some cases, embodiments of the invention are configured to provide authentication and/or authorization services (either through the user interface 315, the data structure 310 and/or the filmmaking application 305 itself)), which can be used to control access to various filmmaking components. (Alternatively and/or additionally, external authentication and/or authorization services, such as those provided by a computer's operating system, by networking software, by other applications, etc., might be relied upon.) In this way, the software may be configured to restrict access various film components to authorized users. In a specific embodiment, for example, a user's ability to access various components might be dependent on the user's authorization to access scenes and/or actions in which those components appear. Likewise, access to groupings of components might be dependent on the user's authorization to access the components within those groupings.

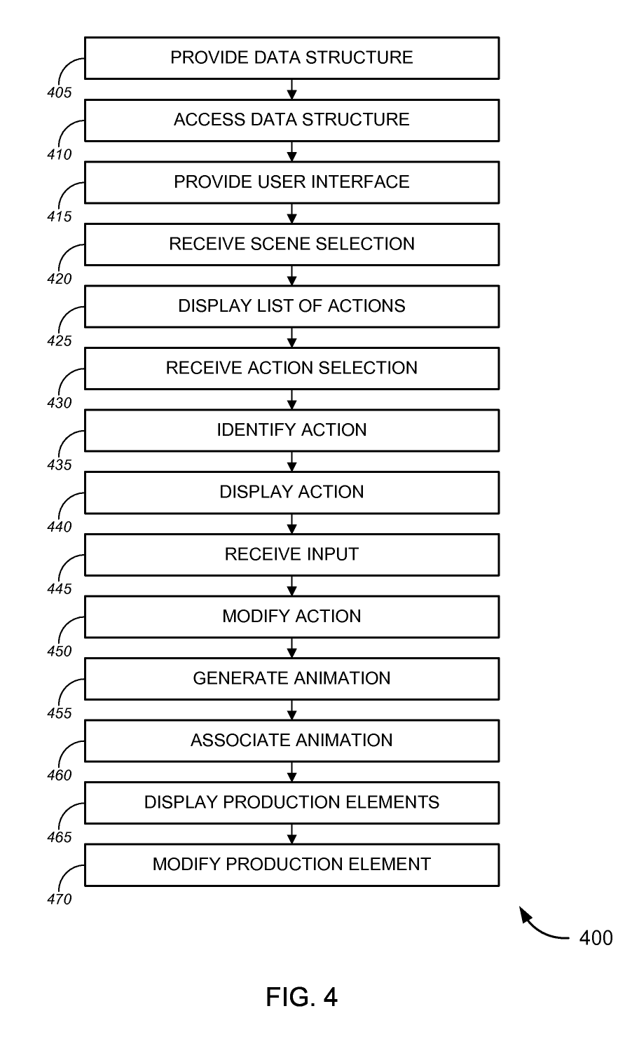

FIG. 4 illustrates a method 400 of organizing data in a filmmaking application in accordance with one set of embodiments (although it should be noted that various other methods of the invention incorporate some, but not all, of the procedures illustrated by FIG. 4). In an aspect, some or all of the procedures of the method 400 may be performed by a computer system (and/or a user operating a computer system), such as the computer system 300 described above. It should be noted, however, that methods of the invention (including, inter alia, the method 400) are not limited to implementation by any particular system or apparatus; likewise, the systems of the invention (including, inter alia, the system 300 described above) are not limited to any particular method of operation.

The method 400 comprises providing a data structure (block 405). Providing a data structure can comprise a variety of tasks, including creating a data structure, storing the data structure on a computer readable medium (e.g., in a database, on a file system, etc.), maintaining and/or updating the data structure, providing access to the data structure, and/or the like. In an embodiment, the data structure is configured to store data about a film, which might be organized into a plurality of scenes, each of which might comprise one or more actions, each of which in turn might employ one or more production elements. In an aspect, the data structure might be similar to the data structures described above, including in particular the data structure 100 described with respect to FIG. 1.

The method 400 further comprises accessing the data structure (block 410) and/or providing a user interface (block 415) for a user to interact with data about the film. In an aspect, a user interface similar to the interfaces 200 and/or 250 might be provided, although other types of user interfaces could be used as well. In another aspect, as noted above, the user interface is configured to accept input from one or more of the input devices described in the Related Applications, including in particular a game controller (such as the controllers that are commonly used to control console video games, such as the XBOX™ from Microsoft™, to name one example). In certain embodiments, as noted above, a user interface might be provided on a client computer, while the remainder of the application might operate on a server computer. In particular embodiments, also as noted above, the user interface might be provided by web server and/or web browser.

In some cases, the user interface is provided by the application that maintains the data structure. In such cases, the application might provide internal facilities for accessing the data structure. In other embodiments, the user interface might be provided by an application separate from the application that maintains the data structure. In such cases, an API and/or any of a variety of standard and/or proprietary data access facilities might be used to access the data structure. For example, if the data structure is provided with an XML structure, an XML parser might be used to access the data structure. Alternatively and/or additionally, if the data structure is stored in a database, any of a number of database access technologies, such as ODBC, JCBC, SQL and/or the like, can be used to access the data structure. In particular embodiments, if the data structure is stored on a file system, the file access facilities provided by the operating system might be used, perhaps in conjunction with some other access technique (including without limitation those described above).

The method 400 further comprises receiving the selection of a scene (block 420). In an aspect, the user interface provides various facilities for selecting scenes, including without limitation those described above. In a particular aspect, the user interface might display some or all of the script, and/or provide a facility for the user to select, from the script, a desired portion of the script. Based on this selection, the corresponding scene might be identified (based upon a relationship between that portion of the script and the scene object representing the scene, for example). Upon receiving the selection of a scene the user interface may be configured to display a list of actions associated with that scene (block 425), again perhaps as described above. In some embodiments, the actions to be listed are identified or determined from one or more relationships between the scene object for the selected scene and action objects representing actions incorporated in the selected scene.

In some cases, the user selects an action from the displayed list, and that selection is received via the user interface (block 430). A few techniques for allowing the user to select the action are described above with respect to FIGS. 2A and 2B. In a set of embodiments, the method 400 further comprises identifying an action (block 435). In an aspect, as noted above, a scene object will have a relationship with one or more action objects pertaining to actions that are incorporated within the scene represented by that scene object, and these relationships can be used to identify the appropriate action. In some cases, the action may be identified based on the user's selection of an action from a list. In other cases, the action can be identified from the user's selection of a portion of the script, based perhaps on a relationship between that portion of the script and the action object.

Once the desired action has been identified, a representation of that action can be displayed for the user (e.g., via the user interface) (block 440). In some cases, displaying a representation of an action might comprise obtaining (e.g., from the action object in the data structure), the representation of the action. In other cases, displaying the representation might comprise giving the action focus within the user interface (such as, for example, displaying the representation of the action in a viewer window and giving the viewer window focus in the user interface).

The user interface may be configurable to display various types of representations of the action, perhaps depending on user input. Merely by way of example, one representation of an action might be textual information that is related to the action; such textual information can include, without limitation, a relevant portion of the script that corresponds to the action, a set of setup information for the action, a set of dialog and/or slug lines used in the action, etc. Another type of representation that can be displayed is a portion of the film itself that comprises the action (including, without limitation, any animations that are used in the action). Yet another displayable representation of the action might be a set of properties of the action object that represents the action.

Optionally, the user might provide input, via the user interface, indicating that the user wishes to modify the action in some way. Upon receiving that input (block 445), the system modifies the selected action (block 450). Modifying the selected action might comprise providing tools to allow the user to modify the selected action as desired. Alternatively, the action might be modified automatically by the application, depending on the type of instructions received from the user. Merely by way of example, if the user modifies a portion of the script, the software might, in response to that modification, modify an action (and/or scene, production element, etc.) that corresponds to (e.g., has a relationship with) that portion of the script. In an aspect, some or all of the modifications to an action might result in modification of the object for that action, and these modifications might then be saved in the data structure.

As an additional example, the user's input might indicate that the user would like to generate a new animation to be associated with that action. (In a sense, as noted above, an animation is associated with a particular production element, since it is the data that specifies how a particular production element moves, acts, etc. Hence, associating an animation with an action might comprise establishing a relationship between an animation and a production element used in the particular action.) In such cases, the user interface might provide a facility (e.g., using an animation tool, which might be, but need not be, incorporated within the software providing the user interface) to allow the user to generate an animation (block 455).

Alternatively, the user's input might indicate that the user wants to associate an existing animation with the selected action (block 460). Associating an animation with an action might simply comprise, as noted above, establishing a relationship between an animation and a production element used in the action. In other cases, associating the animation with an action and/or a production element might further comprise obtaining the animation from a data source (which can include, but is not limited to, the data structures of the invention). In some embodiments, the user might use an external animation application to create animations, and associating an animation with an action and/or production element might therefore comprise importing the animation from outside the filmmaking application. The animation might be imported, for example, into the application that provides the user interface and/or the data structure, and/or importing the animation into the data structure itself (e.g., creating an animation object for the animation, relating the animation object to a production element object and/or action object, etc.)

In a set of embodiments, as noted above, an action might comprise and/or employ one or more production elements, and the user interface therefore might display a representation of one or more of the production elements (block 465) used by and/or incorporated in the action. Similar to actions, a variety of different types of representations of production elements can be displayed. In some cases, for example, a browser window (e.g., the browser window 205 of FIG. 2A) and/or hierarchical display (e.g., the display 250 of FIG. 2B) might display a list of production elements. Additionally and/or alternatively, a viewer window (e.g., the viewer window 210 of FIG. 2A) might display other types of representations of a given production element, In some cases, the representation of the production element might vary according to the type of production element selected. Merely by way of example, for virtual characters, props, etc., the production element itself might be displayed, and/or for characters, lighting equipment, camera equipment, etc., the relevant rig might be displayed, either textually and/or graphically. Displaying a representation of a production element might also include displaying properties of the object representing the production element, displaying tags associated with the production element, and/or the like. Further, displaying an element could also comprise identifying portions of the script (such as text, names, dialog, locations, and/or the like) pertaining to the production element and/or displaying such portions of the script (e.g., as text) with the user interface.

The user input might further indicate that the user desires to modify a production element, and the method 400, therefore, might comprise modifying the production element in response to the user's input (block 470). Modifying a production element can comprise a variety of tasks. Merely by way of example, a behavior of the production element can be defined (e.g., a behavior within an action, which might be embodied in an animation using the production element). Various properties of the production element's object can be modified, either textually or graphically, using tools provided by the user interface and/or an associated filmmaking/animation software program. In some cases, modifying the production element can include creating new tags to be associated with the production element and/or associating one or more existing tags with the production element. In another aspect, modifying the production element might comprise associating (and/or disassociating) the production element with a particular action, scene, etc., in the manner described above, for example. In an aspect, some or all of the modifications to the production element might result in changes to the production element's object, which can then be saved in the data structure. (As noted above, a production element may also be modified by modifying a corresponding portion of the script, and/or vice-versa.)

FIG. 5 provides a schematic illustration of one embodiment of a computer system 500 that can perform the methods of the invention, as described herein, and/or can function as a user computer, server computer, and/or the like. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like (as well as any of the input devices described above and in the Related Applications); and one or more output devices 520, which can include without limitation a display device, a printer and/or the like.

The computer system 500 may further include (and/or be in communication with) one or more storage devices 525, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540 and/or other code, such as one or more application programs 545, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 500) to perform methods of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another machine-readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 500, various machine-readable media might be involved in providing instructions/code to processor(s) 510 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 525. Volatile media includes, without limitation dynamic memory, such as the working memory 535. Transmission media includes coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

As noted above, a set of embodiments comprises systems for organizing and/or displaying data in a filmmaking application. Merely by way of example, FIG. 6 illustrates a schematic diagram of a system 600 that can be used in accordance with one set of embodiments. The system 600 can include one or more user computers 605 (which can provide a user interface, provide a data structure, etc. in accordance with embodiments of the invention). The user computers 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 605 can also have any of a variety of applications, including one or more applications configured to perform methods of the invention, as well as one or more office applications, database client and/or server applications, and web browser applications. Alternatively, the user computers 605 can be any other electronic device, such as a thin-client computer, Internet-enabled mobile telephone, and/or personal digital assistant, capable of communicating via a network (e.g., the network 610 described below) and/or displaying and navigating web pages or other types of electronic documents. Although the exemplary system 600 is shown with three user computers 605, any number of user computers can be supported.

Certain embodiments of the invention operate in a networked environment, which can include a network 610. The network 610 can be any type of network familiar to those skilled in the art that can support data communications using any of a variety of commercially-available protocols, including without limitation TCP/IP, SNA, IPX, AppleTalk, and the like. Merely by way of example, the network 610 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can include one or more applications (including, without limitation, filmmaking applications, such as those described herein and/or in the Related Applications, and/or applications configured to provide user interfaces and/or data structures in accordance with embodiments of the invention) accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to provide some or all of a user interface, such as the user interfaces described above). Merely by way of example, a web application can be implemented as one or more scripts or programs written in any suitable programming language, such as Java™, Visual Basic™, C, C#™ or C++, and/or any scripting language, such as Perl, Python, or TCL, as well as combinations of any programming/scripting languages.

The application server(s) can also include database servers, including without limitation those commercially available from Oracle, Microsoft, Sybase™, IBM™ and the like, which can process requests from clients (including, depending on the configuration, database clients, API clients, web browsers, etc.) running on a user computer 605 and/or another server 615. In some embodiments, an application server can create web pages dynamically for displaying the information in accordance with embodiments of the invention, such as, for example, web pages configured to provide a user interface, as described above. Data provided by an application server may be formatted as web pages (comprising HTML, Javascript, etc., for example) and/or may be forwarded to a user computer 605 via a web server (as described above, for example). Similarly, a web server might receive web page requests and/or input data from a user computer 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement methods of the invention incorporated by an application running on a user computer 605 and/or another server 615. Alternatively, as those skilled in the art will appreciate, a file server can include all necessary files, allowing such an application to be invoked remotely by a user computer 605 and/or server 615. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620 (which may be, but need not be, configured to store data structures of the invention). The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 635 can be a relational database, such as an Oracle database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of organizing data in computer-assisted filmmaking application, the method comprising:
accessing a data structure, the data structure being configured to store data about a film, the film being organized into a plurality of scenes, each scene comprising one or more actions, each action employing one or more production elements;
providing a user interface for a user to interact with the data about the film;
receiving, via the user interface, a selection of a first scene, the first scene comprising a first action;
identifying the first action, based on the selection of the first scene; and
displaying, via the user interface, a representation of the first action.

2. The method of claim 1, wherein the first scene comprises a plurality of actions, the plurality of actions comprising the first action, and wherein identifying the first action comprises:
displaying a list of the plurality of actions; and
receiving a selection the first action from the plurality of actions.

3. The method of claim 1, wherein providing a user interface comprises providing a user interface that accepts input from a game controller.

4. The method of claim 1, wherein the data structure comprises:
a plurality of scene objects, including a first scene object corresponding to the first scene;
a plurality of action objects, including a first action object corresponding to the first action; and
a plurality of production element objects, including a first production element object corresponding to a first production element in the film.

5. The method of claim 4, wherein the first production element object has associated therewith a plurality of tags, each of the plurality of tags identifying a characteristic of the first production element.

6. The method of claim 5, wherein the first production element is of a specified production element type, and wherein the plurality of tags comprises a first set of tags defined by the production element type.

7. The method of claim 6, wherein the specified production element type is selected from the group of production element types consisting of: a character production element type, a prop production element type, a camera production element type, and a light production element type.

8. The method of claim 5, wherein the plurality of tags comprises one or more user-defined tags.

9. The method of claim 4, wherein data structure further comprises a first relationship between the first scene object and the first action object, indicating that the first scene comprises the first action, and a second relationship between the first action object and the first production element object, indicating that the first production element is used in the first action.

10. The method of claim 9, wherein identifying the first action comprises identifying the first action based on the first relationship.

11. The method of claim 1, wherein receiving a selection of a first scene comprises:
displaying, in the user interface, at least a portion of a script of the film;
receiving a selection from the at least a portion of the script; and
identifying the first scene based on the selection from the at least a portion of the script.

12. The method of claim 11, wherein identifying the first action comprises identifying the first action based on the selection from the at least a portion of the script.

13. The method of claim 11, wherein the first action uses a plurality of production elements, and wherein the method further comprises:
identifying one of the plurality of production elements, based on the selection from the at least a portion of the script.

14. The method of claim 1, further comprising:
receiving user input via the user interface; and
in response to the user input, modifying a portion of a script of the film.

15. The method of claim 14, wherein the portion of the script corresponds to the first scene, the method further comprising:
modifying the first scene in response to a modification of the portion of the script.

16. The method of claim 14, wherein the portion of the script corresponds to the first action, the method further comprising:
modifying the first action in response to a modification of the portion of the script.

17. The method of claim 14, wherein the first action uses a production element, and wherein the portion of the script corresponds to a the production element, the method further comprising:
modifying the production element in response to a modification of the portion of the script.

18. The method of claim 1, wherein displaying the representation of the first action comprises obtaining the representation of the first action from the data structure.

19. The method of claim 1, wherein displaying the representation of the first action comprises giving the first action focus within the user interface.

20. The method of claim 1, wherein the film comprises a script, and wherein displaying the representation of the first action comprises displaying a first portion of the script, the first portion of the script corresponding to the first action or the first scene.

21. The method of claim 1, wherein displaying the representation of the first action comprises displaying a portion of the film comprising the first action.

22. The method of claim 1, further comprising: receiving, via the user interface, input from the user; and in response to the input from the user, modifying the first action.

23. The method of claim 22, wherein modifying the first action comprises associating one or more animations with the first action.

24. The method of claim 23, wherein associating one or more animations with the first action comprises establishing a relationship between the one or more animations and the first production element.

25. The method of claim 23, wherein associating one or more animations with the first action comprises an operation selected from the group consisting of generating an animation for the first action, associating an existing animation with the first action, and importing an existing animation from outside the filmmaking application.

26. The method of claim 25, wherein associating an existing animation with the first action comprises obtaining an existing animation from a data source.

27. The method of claim 1, wherein the first action is associated with a plurality of production elements, the plurality of production elements comprising a first production element, and wherein the method further comprises:
displaying, via the user interface, representations of at least some of the plurality of production elements, including a representation of the first production element.

28. The method of claim 27, wherein the method further comprises: receiving, via the user interface, input from the user; and
modifying the first production element, in response to the input from the user.

29. The method of claim 27, wherein the plurality of production elements comprise a first production element, and wherein the method further comprises:
receiving, via the user interface, input from the user; and
defining a behavior of the first production element within the action, in response to the input from the user.

30. The method of claim 27, wherein the plurality of production elements comprise a first production element, and wherein the method further comprises:
receiving, via the user interface, input from the user; and
associating a tag with the first production element, in response to the input from the user, wherein the tag identifies a characteristic of the first production element.

31. The method of claim 1, wherein the film is a live-action film.

32. The method of claim 1, wherein the film is an animated film.

33. A data structure, encoded on a computer readable medium, for storing data used by a computer-assisted filmmaking application, the data structure comprising:
a plurality of scene objects comprising data about a plurality of scenes in a film, the plurality of scene objects comprising a first scene object representing a first scene in the film and having a first scene identifier;
a plurality of action objects comprising data about a plurality of actions within the film, the plurality of action objects comprising a first action object representing a first action and having a first action identifier, and a second action object representing a second action and having a second action identifier; and
a plurality of production element objects comprising data about a plurality of production elements within the film, the plurality of production element objects comprising a first production element object having a first production element identifier and a second production element object having a second production element identifier;
a first relationship between the first scene object and the first action object, indicating that the first scene comprises the first action; and
a second relationship between the first action object and the first production element object, indicating that the first production element is used in the first action.

34. The data structure of claim 33, wherein the data structure configures a computer system to display a user interface that indicates that the first scene comprises the first action and the first action uses the first production element.

35. The data structure of claim 33,wherein the first relationship comprises a reference in the first action object to the first scene object, and wherein the second relationship comprises a reference in the first production element object to the first action object.

36. The data structure of claim 33, wherein the first relationship comprises a reference in the first scene object to the first action object, and wherein the second relationship comprises a reference in the first action object to the first production element object.

37. The data structure of claim 33, wherein the data structure is implemented by a set of instructions encoded on the computer readable medium, the set of instructions being executable by a computer system.

38. The data structure of claim 33, wherein each scene object is defined by a scene data class, wherein each action object is defined by an action data class, and wherein each production element object is defined by a production element data class.

39. The data structure of claim 33, wherein the first production element object comprises a rig having a set of controls, the set of controls comprising a first control for controlling a first manipulable property of the first production element.

40. The data structure of claim 33, wherein the first production element is associated with a tag that identifies a characteristic of the first production element.

41. The data structure of claim 40, wherein the data structure comprises an array of tags, the array of tags comprising the first tag, and wherein the array of tags is searchable by a user to identify one or more production elements with a specified characteristic.

42. A computer readable medium having encoded thereon a computer program comprising a set of instructions executable by a computer to generate a user interface for a computer-assisted filmmaking application, the user interface comprising:
a scene selection element for a user to select a first scene object corresponding to a scene from a film, wherein the scene object is related to a plurality of action objects, the plurality of action objects comprising a first action object corresponding to a first action and a second action object corresponding to a second action, and wherein the scene comprises the first and second actions;
an action selection element for a user to select one of the plurality of action objects; and
an action modification element for a user to modify the selected one of the plurality of action objects.

43. The computer readable medium of claim 42, wherein the user interface is further configured to display a portion of a script for the film, the portion of the script corresponding to the selected one of the plurality of action objects.

44. The computer readable medium of claim 42, wherein the selected one of the plurality of action objects is the first action object, wherein the first action object is related to a plurality of production element objects, and wherein the user interface further comprises:
a production element selection element for a user to select a production element; and
a production element modification element for the user to modify the selected production element.

45. The computer readable medium of claim 42, wherein the filmmaking application comprises a data structure, the data structure comprising:
a plurality of scene objects comprising data about a plurality of scenes in a film, the plurality of scene objects comprising the first scene object having a first scene identifier;
the plurality of action objects comprising data about the plurality of actions within the film, the plurality of action objects comprising the first action having a first action identifier, and the second action object having a second action identifier; and
the plurality of production element objects comprising data about a plurality of production elements within the film, the plurality of production element objects comprising a first production element object and a second production element object.

46. A computer system, comprising:
a processor; and
a computer readable medium in communication with the processor, the computer readable medium having encoded thereon:
a data structure to store data about a film, the film being organized into a plurality of scenes, each scene comprising one or more actions, each action employing one or more production elements; and
a computer program comprising a set of instructions executable by the computer system to perform one or more operations, the set of instructions comprising:
instructions for accessing the data structure;
instructions for providing a user interface for a user to interact with the data about the film;
instructions for receiving, via the user interface, a selection of a first scene, the first scene comprising a first action;
instructions for identifying the first action, based on the selection of the first scene; and
instructions for displaying, via the user interface, a representation of the first action.

47. The computer system of claim 46, wherein the computer system is a server computer, and wherein the instructions for providing a user interface comprise instructions for communicating with a client computer, the client computer being configured to display the user interface.

48. The computer system of claim 47, wherein communicating with a client computer comprises communicating with a web browser on the client computer via a web server to cause the web browser to display the user interface.

49. The computer system of claim 48, wherein the computer system comprises the web server.

50. A computer readable medium having encoded thereon a computer program comprising a set of instructions executable by a computer to perform one or more operations, the set of instructions comprising:
instructions for accessing a data structure, the data structure being configured to store data about a film, the film being organized into a plurality of scenes, each scene comprising one or more actions, each action employing one or more production elements;
instructions for providing a user interface for a user to interact with the data about the film;
instructions for receiving, via the user interface, a selection of a first scene, the first scene comprising a first action;
instructions for identifying the first action, based on the selection of the first scene; and
instructions for displaying, via the user interface, a representation of the first action.
